(19) United States
(12) Patent Application Publication
(10) Pub. No.: US 2009/0319385 A1
(43) Pub. Date: Dec. 24, 2009

(54) MONETIZING AND PRIORITIZING RESULTS OF A DISTRIBUTED SEARCH

(76) Inventors: Bruce Kelly JACKSON, Bournemouth Dorset (GB); Mark Leslie CAUNTER, Christchurch (GB); Steven GEACH, Weymouth Dorset (GB)

Correspondence Address: QUALCOMM INCORPORATED, 5775 MOREHOUSE DR., SAN DIEGO, CA, 92121, US

(21) Appl. No.: 12/141,523

(22) Filed: Jun. 18, 2008

(51) Int. Cl. G06F 7/06; G06F 17/30; G06F 21/00; G06Q 30/00

(52) U.S. Cl. 705/26; 707/5; 726/3; 707/E17.108

(57) ABSTRACT

An operator provides services to a population of client device, such as mobile communication devices, including search services accessed via an operator portal. A search gateway places a search object, in which user privacy is protected, into a distributed, transactional object (tuple) space. Resolvers monitoring the space read the search descriptors and coordinate an external search to be performed with result objects placed back in the space. The gateway removes the search result objects from the space, matching them with the user search for reporting to a user of the client device. Thereby, an increased amount of content is accessible across a distributed system.

### REFERENCE TO CO-PENDING APPLICATIONS FOR PATENT

The present Application for Patent is related to the co-pending U.S. patent application Ser. No. ______, entitled “User Interfaces For Service Object Located In A Distributed System” by Jackson et al., having Attorney Docket No. 070833, filed on even date herewith, assigned to the assignee hereof, and expressly incorporated by reference herein, and U.S. patent application Ser. No. ______, entitled “Method for Carrying Out a Distributed Search” to Jackson et al., having Attorney Docket No. 061511, filed on even date herewith, assigned to the assignee hereof and hereby expressly incorporated by reference herein.

### BACKGROUND

1. Field

The described aspects relate to interactive workspaces and ubiquitous computing. More particularly, it pertains to an infrastructure for a population of disparate computing platforms to readily utilize one or more separate search services located in a distributed system whose results can generate revenue to an operator.

2. Background

Operators for a population of users of client devices compete in a competitive, evolving communication marketplace. It is difficult to satisfy user expectations for various services, especially over distributed computer systems. Often, user expectations are at variance with each other in having different preferred service providers, which is particularly true for searching. In addition, certain types of content can be segregated in different nodes of a distributed network with proprietary search engines that frustrate meta-searching.

A distributed computer system, such as but not limited to the Internet, is characterized by rapid, real-time interchange among many dissimilar processes executing simultaneously on a large array of dissimilar and geographically diverse processors. A distributed computer system's resources are usually spatially separated, and the execution of its applications often involves multiple execution threads that can be widely separated in time.

With these difficulties for users to obtain their preferred search results, a corresponding difficulty exists for search engine providers, maintainers of proprietary searchable data content, and advertisers of goods or services that are sought through such searching to get the attention of users of client devices. That is particularly true of user's of client devices that are mobile communication devices. The intermittent viewing, the constrained user interfaces, and limited communication channel bandwidth limits opportunities to prominently present search results in a rated fashion.

### SUMMARY

The following presents a simplified summary in order to provide a basic understanding of some aspects of the present disclosure. This summary is not an extensive overview and is intended to neither identify key or critical elements nor delineate the scope of such aspects. Its purpose is to present some concepts of the described aspects in a simplified form as a prelude to the more detailed description that is presented later.

In accordance with one or more aspects and corresponding disclosure thereof, various features are described in connection with use of a client device, such as a handheld communication device, for searching for content via a loosely coupled, distributed network. In particular, an operator for a population of client devices can generate revenues and perhaps a more relevant searching capability by soliciting bids associated with search result for prominently ranking these results for the client device.

In one aspect, a method facilitates a rated, distributed search by defining a search rating bid process in a tuple space. A search object is placed in the tuple space based on a search query from a client device. A plurality of search result objects are detected as having been placed in the tuple space. At least one rating bid associated with a selected one of the plurality of search result objects is received. Then, the search results are returned to the client device with the selected one of the search results objects prominently ranked.

In other aspects, at least one processor includes modules for performing the rated, distributed search facilitating method. A computer program product includes instructions for performing the rated, distributed search facilitating method. An apparatus providing means for performing the rated, distributed search facilitating method.

In yet another aspect, an apparatus facilitates a rated, distributed search with a tuple space. An operator portal receives a search query from a client device. A search gateway connected to the operator portal and to the tuple space places a search object in the tuple space based on the search query from a client device. The search gateway detects a plurality of search result objects placed in the tuple space and receives at least one rating bid associated with a selected one of the plurality of search result objects. The operator portal returns the search results to the client device with the selected one of the search results objects prominently ranked responsive to the rating bid.

In an additional aspect, a method for requesting a rated, distributed search accepts input of a search query into a user interface of a client device. The search query is sent to a network that defines a search rating bid process in a tuple space, places a search object in the tuple space from a client device, detects a plurality of search result objects placed in the tuple space, receives at least one rating bid associated with a selected one of the plurality of search result objects. The search results are received by the client device with the selected one of the search results objects prominently ranked by the network.

In other aspects, at least one processor includes modules for performing the rated, distributed search requesting method. A computer program product includes instructions for performing the rated, distributed search requesting method. An apparatus providing means for performing the rated, distributed search requesting method.

In yet a further aspect, an apparatus for requesting a rated, distributed search has a user interface of a client device for accepting input of a search query. A communication component sends the search query to a network that defines a search rating bid process in a tuple space, places a search object in the tuple space from a client device, detects a plurality of search result objects placed in the tuple space, receives at least one rating bid associated with a selected one of the plurality of search result objects, and receiving the search results to the client device. The user interface then presents the search results with the selected one of the search results objects prominently ranked by the network.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects and versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

FIG. 1 is a schematic diagram of one aspect of a system for an operator to utilize one or more separate search capabilities across a distributed network.

FIG. 2 is a schematic diagram of one aspect of a communication network operable with the system of FIG. 1.

FIG. 3 is a diagram of an illustrative client device having an optimized rated search results displaced, according to one aspect.

FIG. 4 is a timing diagram of a methodology performed by the distributed network of FIG. 1 for searching across one or more separate searching entities of a distributed network and optimizing result rankings in accordance with search bids, according to one aspect.

FIG. 5 is a flow diagram of a methodology for distributed searching and result rating performed by the operator of FIG. 1, according to one aspect.

### DETAILED DESCRIPTION

An operator provides services to a population of client device, such as mobile communication devices, including search services accessed via an operator portal. A search gateway places a search object containing search descriptors extracted from the portal input. The search object, which protects user privacy, is put into a distributed, transactional object (tuple) space. Resolvers monitoring the space read the search descriptors and coordinate an external search to be performed with result objects placed back in the space. The gateway removes the search result objects from the space, matching them with the user search for reporting to a user of the client device. Thereby, an increased amount of content is accessible across a distributed system.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

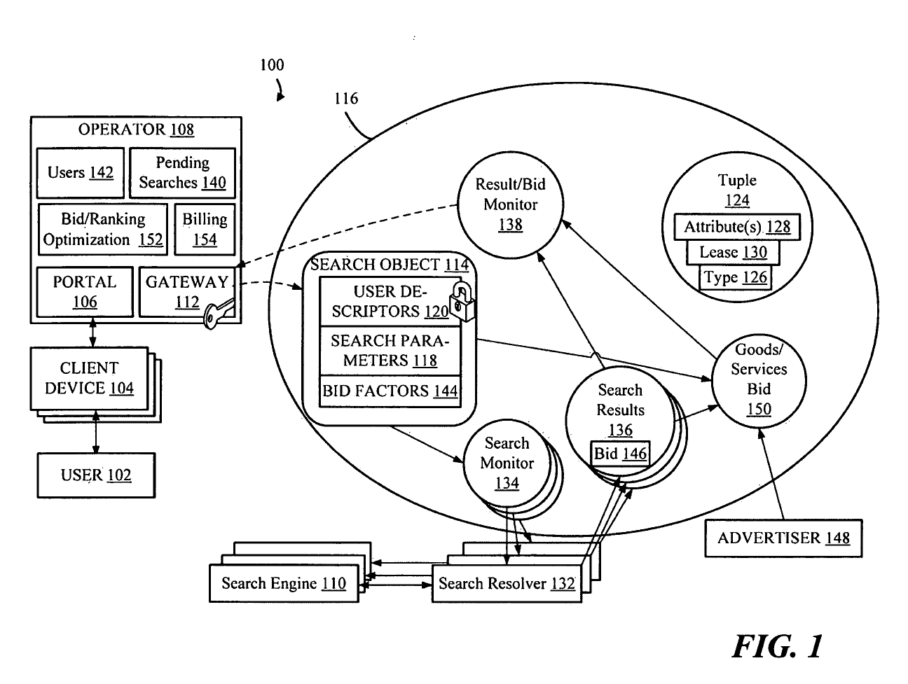

In FIG. 1, a distributed system 100 allows users 102 of client devices 104, such as mobile communication devices, to access a portal 106 of an operator 108 in order to access search results from one or more search engines 110, according to one aspect. In order to address the challenges of “off-portal” content, the operator 108 utilizes a search gateway 112 that creates a search object 114 that is placed in a Linda-style distributed, transactional system (“tuple space”) 116. The search gateway 112 constructs the search object by creating search descriptors 118, which can include the actual search terms and additionally other parameters such as a type of content media and other search restrictions. An object body 120 captures identification of the user 102 and how to return the search results to the user 102; however, this information is visible only to the search gateway.

The search object 114 is a tuple that interacts with other tuples to receive the requested search, and perhaps bid, information. A “tuple space” is a globally shared, associatively addressed memory space that is organized as a grouping of tuples. A “tuple” is the basic element of a tuple space system. In the context of a tuple space based coordination language like Linda, a tuple is a vector having fields or values of certain types. In a broader sense, a “tuple” is an entry in an information storage system. For example, a row in a relational database system can be referred to as a tuple.

In Linda-like languages, constructs called “templates” are used to associatively address tuples via matching techniques. A template matches a tuple if they have an equal number of fields and if each template field matches the corresponding tuple field.

Tuple space based coordination languages provide a simple yet powerful mechanism for inter-process communication and synchronization, which is the crux of parallel and distributed programming. A process with data to share generates a tuple and places it into the tuple space. A process requiring data simply requests a tuple from the tuple space.

Tuple space programs may be easier to write and maintain for a number of reasons including the following:

(1) Destination uncoupling (fully anonymous communication)—the creator of a tuple requires no knowledge about the future use of that tuple or its destination.

(2) Spatial uncoupling—because tuples are retrieved using an associative addressing scheme, multiple address-space-disjoint processes can access tuples in the same way.

(3) Temporal uncoupling—tuples have their own life span, independent of the processes that generated them or any processes that may read them. This enables time-disjoint processes to communicate seamlessly.

The implementation of the tuple space can be either “closed” or “open.” The closed implementations use compile time analysis of object and source code to provide highly efficient closed programs. The open implementations allow processes, agents, and programs to coordinate through tuple spaces without the run-time system requiring any prior knowledge. Essentially, the open implementations provide a persistent data store.

The Linda language uses three standard instructions or primitives. These are (with their informal semantics):

(1) out(tuple) Insert a tuple into a tuple space.

(2) in(template) If a tuple exists that matches the template, then remove the tuple and return it to the agent performing the in. If no matching tuple is available, then the primitive blocks until a matching tuple is available.

(3) rd(template) If a tuple exists that matches the template, then return a copy of the tuple to the agent that performed the rd. If there is no matching tuple, then the primitive blocks until a matching tuple is available.

Returning to FIG. 1, tuple space 116 comprises a data repository, and each of a search object (data tuple) 114 placed in tuple space 116 by the search gateway 112 and an illustrative service tuple 124 in tuple space 116 each comprise an object having an ordered set of data comprising a tuple type 126 and tuple attributes 128. Further, tuple attributes 128 may vary depending upon tuple type 126. The tuple space 116 comprises an abstract space operable to receive data objects, e.g. tuple 124, and includes a predetermined set of operations that can be performed within the space. For example, the predetermined set of functions may include an “in” function and a “rd” function, which both take input parameters that allow the selection of specific tuples in the space by matching the input parameters, where given, with those values present within the tuple space. Additionally, both the “in” and “rd” functions may have non-blocking equivalents (inp and rdp). In some aspects, the predetermined set of functions may include a set of operations, such as JAVA methods, that may be performed on both tuple space 116 and tuple 124.

Further, in a specific example, each tuple 124 is an instance of a com.qualcomm.qspaces.linda.Tuple class or subclass, and is created with a set of attributes 128, defined by an array of objects which are specified when the tuple 124 is constructed. The array can be zero-length, however, in some aspects, the array may not be null. In addition, in some aspects, none of the individual attribute objects in the array may be null.

In some aspects, when the tuple 124 is first constructed, and every time the respective attributes 128 are retrieved from the respective tuple, the array of objects may be defensively copied using a very fast form of in-memory serialization. This process allows the tuple 124 to be immutable, and therefore, guarantees the integrity of tuple space 116 in which the tuple 124 resides.

In the above-noted aspects, tuple equality adheres to the same equality principles of any JAVA object, including the symmetry rule which states that if t1.equals(t2) then t2.equals(t1).

Specifically, a tuple equals another tuple, e.g. t1.equals(t2), if t2, known as a template, meets the following criteria:

1) The class 126 of the template t2 is the same class 126 as the tuple t1.

2) The attributes 128 of the template t2 are equal to the attributes 128 of the tuple t1, meaning that t2's attributes 128 are the same as t1's attributes 128, irrespective of their order.

In other aspects, a tuple matches another tuple, e.g. t1.matches(t2), if t2, known as a template, meets the following criteria:

1) The class 126 of the template t2 is the same class 126 or a super class of the tuple t1.

2) The attributes 128 of the template t2 match the attributes 128 of the tuple t1, meaning that t2's attributes 128 are the same set or a subset of t1's attributes 128, irrespective of their order.

When matching one tuple with another, the symmetry rule does not apply; so, t1.matches(t2) does not necessarily equate to t2.matches(t1).

In some aspects, the comparison of one set of tuple attributes 128 with another uses the normal object equality rules, so any object used as a tuple attribute 128 can implement the object.equals(Object obj) and object.hashcode( ) methods.

A tuple 124 is added to tuple space 116 with a lease 130. Lease 130 is a period of time, for example specified in milliseconds, which defines how long the tuple will remain in the respective tuple space 116. For example, lease 130 having a value of zero may indicate that the respective tuple never expires. Once lease 130 has expired for a respective tuple, the tuple is automatically removed from tuple space 116.

The depicted tuple 124 can be a service tuple rather than a data tuple, such as search object 1 14. Service tuples 124 represent services that interact with clients of the tuple space 116, such as gateway 112. Further, service tuples 124 are also autonomous “live” JAVA objects in their own right, which may also interact with tuple space 116 and other tuples in the space. Service tuples 124 may be discovered in the same manner as other tuples, e.g. by matching the class 126 and attributes 128 of the tuple. In some aspects, service tuples 124 may not be used in this way, however, rather service tuples 106 are interacted with indirectly by placing other tuples, such as data tuples 114, into tuple space 116.

For example, a client, such as a respective gateway 112, may create data tuple 124 of class A with attributes “abc” and “123,” and places the tuple into tuple space 116. As such, data tuple 124 can be described using the following notation:
(A, “abc”, 123).

Service tuple 124 is a live object which can interact with tuple space 116 in the same way as a client application. As such, in this example, service tuple 124 has been instantiated and is blocking on a read from tuple space 116 for any tuples with a matching template 126 for class A and any attributes. Such a matching criterion can be described as follows:
(A, ?s, ?x)
   where ?s and ?x mean that any values of the string s and the integer x will be matched. Consequently, tuple space 116 matches the template from service tuple 124, and will then read tuple 114 from tuple space 116. In this manner, the described aspects pass parameters in the form of tuples to a service.

Further, in system 100, it is possible to embed objects that represent user interfaces into the service objects themselves. Consider the following user interface service tuple:
(A, [Java], [Flash], [uiOne])
   Such a service tuple (not shown) contains three user interface objects defined in JAVA™, ADOBE FLASH, and uiOne™ technologies of QUALCOMM Incorporated of San Diego, Calif. In the context of mobility, the present aspects enable the offering of a service across a wide variety of wireless devices, each with its own specific requirements, whether in terms of support of different technologies such as Java, Flash or uiOne, or even multiple variants of a single technology, optionally including optimizations for screen size or other device-specific properties. Thus, the ability to readily communicate is enhanced with distributed computing entities represented in tuple space 116 by being able to locate a user interface service object and then load user interface components from it.

Referring back to FIG. 1, one or more search resolvers 132 are connected to the tuple space 132, perhaps dynamically. The resolvers 132 are depicted as monitoring the tuple space 116 for search objects 114 with a search monitor tuple 134. The resolvers 132 serve as a custom search mechanism to format the search descriptors 118 into an approach search query format for a respective search engine 110. In some instances, the descriptors 118 suggest limitations that render a particular search engine in appropriate for the search, such as for search engines dedicated to a specialized database of media content that is not sought (e.g., audio MP3 files). It should be appreciated that various combinations and numbers of search engines 110 thus may be dynamically enlisted to perform the search. Upon completion of the respective searches, each search resolver 132 creates a search results tuple 136 that is placed back in tuple space 116.

The search gateway 112 of the operator 108 monitors the tuple space 116 for the results of this search and perhaps a number of other pending searches for other users 102 of client devices 104. This monitoring is depicted by a result/bid monitor tuple 138. For instance, a service tuple can watch for results for all searches or a custom data tuple can be placed into the space 116 for each pending search, perhaps with a lease 130 selected for a time duration allocated for the search. Upon detection of search results tuple 136, the gateway 112 causes these tuples 136 to be removed from the space 116. The private object body 120 contained in each search result tuple 136 is extracted so that the one or more sets of search results can be collected and returned to the correct user 102 via the portal 106.

It should be appreciated that the object body 120 can be sufficient to identify the users 102 by itself, and way to send the results to the corresponding client device 104. Alternatively, for increased privacy and/or reduced message size or other reasons, the object body 120 can be limited to a unique code that can be referenced to a pending searches data structure 140 maintained by the operator 108. In addition, usage of the portal 106 can be monitored for billing purposes (e.g., a per search charge, etc.) or restricted (e.g., authorized users, etc.) with reference to a users database 142 maintained by the operator 108.

As a way to advantageously rank search results in a way that has great applicability to the user 102 and/or to enhance revenue generated by providing the search service, the gateway 112 can solicit rating bids as part of placing the search object 114 into the space 116. Such arrangements can be pre-existing and implicit. Alternatively or in addition, each search object 114 can solicit bids by incorporating a bid factors attribute 144 that is optionally operated on by search resolver 132. For instance, the bid factors attribute 144 can specify bid parameters to be reported (e.g., identity of bidder, bid value for top placement, bid value for placement within the first five listings, bid value for placement within the first screen of a constrained mobile device display, etc.). The bid factors attribute 144 can include demographic information about the user that could be valued by an advertiser (e.g., location, age group, socioeconomic class, etc.) The search resolvers 132 can thus include a bid response attribute 146 as part of the search results 136.

Alternatively or in addition, third parties such as advertisers 148 can monitor the space 116 for applicable research objects 114 and/or search results objects 136 with a goods/services bid tuple 150 that provides a bid to the result/bid monitor 138. The gateway 112 thus associates these bids with the appropriate search and performs a bid/ranking optimization process 152, noting acceptance of bids in a billing component 154 for a subsequent billing event.

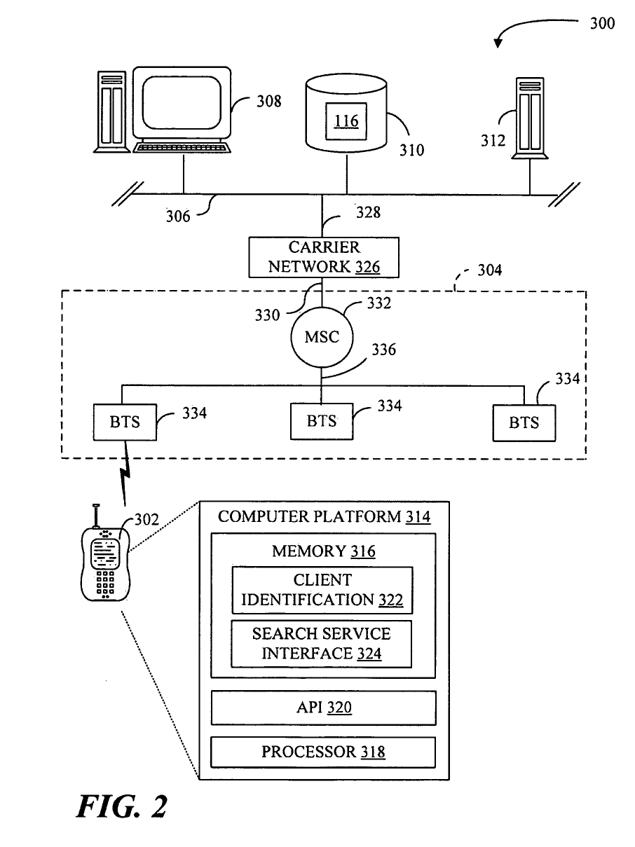

Referring to FIG. 2, for example, a communications network 300 includes one or a plurality of client devices 302, wireless telephone devices in this case, that utilizes a wireless network 304 to communicate with wired network 306 (e.g. a local area network, LAN) having network device or server 308 and/or storage device 310 and/or data source 312. One or both of network device/server 308 and/or storage device 310 may include tuple space 116 and some portions the above-discussed components of system 100. Further data source 312 may include a processor and a memory in communication with the processor, wherein the memory comprises a tuple generation module having tuple generation logic operable to generate a plurality of data tuples from any source of data operable to readily interface with unknown services, such as a web-based transactional service. In particular, wireless device 102 includes a computer platform 314 having a memory 316 in communication with a processor 318, such as via an application programming interface (API) 320 that enables interaction with any resident applications, such as client identification component 322 and a search service interface 324 sufficient for using the portal 106 (FIG. 1) that is located in tuple space 116.

Further, network device or server 308 and/or storage device 310 and/or data source 312 may include a processor and a memory in communication with the processor, as well as an interfacing, search and rating module (not depicted) stored in the memory and executable by the processor, wherein the interface, search and rating module comprises tuple space 116, search service tuple 106, and rating service tuple 118, described above. Wireless network 304 is connected to wired network 306 via a carrier network 326. Network device or server 308 and/or storage device 310 and/or data source 312 may be present on communications network 300 with any other network components that are desired to provide community management capabilities and/or cellular telecommunication services. Network device or server 308 and/or storage device 310 and/or data source 312 may communicate with carrier network 326 through data links 328 and 330, which may be data links such as the Internet, a secure LAN, WAN, or other network. Carrier network 326 controls messages (generally being data packets) sent to a mobile switching center (MSC) 332. Further, carrier network 326 communicates with MSC 332 by the network 330, such as the Internet, and/or POTS (plain old telephone service). For example, in network 330, a network, or Internet portion transfers data and the POTS portion transfers voice information. MSC 332 may be connected to multiple base stations (BTS) 334 by another network 336, such as a data network and/or Internet portion for data transfer and a POTS portion for voice information. BTS 334 ultimately broadcasts messages wirelessly to the wireless communication devices 302, for example using predetermined voice and/or data packet services, such as Code Division Multiple Access (CDMA) and short messaging service (SMS), respectively, or any other over-the-air methods. Thus, communication network 300, in combination with system 100 (FIG. 1), allow for the search initiation and reporting between data objects in a tuple space 116.

It should be noted that FIG. 2 is a representative diagram that more fully illustrates the components of a wireless communication network and the interrelation of the elements of one aspect of the present system. Communications network 300 is merely exemplary and can include any system whereby remote modules, such as wireless communication devices 302, communicate over-the-air between and among each other and/or between and among other components of a wireless and/or wired network, including, without limitation, wireless network carriers, and/or servers.

In FIG. 6, an illustrative mobile communication device 400 can serve as client device for remotely accessing and controlling interface, search and rating services via a graphical user interface (GUI) 402, which can include physical controls such as dial tone multi-function (DTMF) keypad 404, with four cursor keys 406 and select button 408, and left, middle and right menu buttons 410, 412, and 414. The GUI 402 can include a display 416 as depicted. Alternatively, a display with touch screen capability can also be used to provide soft input controls (not shown). The display 416 can depict a dynamic index 418 organized under a hierarchy of tabs of a search tab 420, player 422 tab, a find (local) tab 424 and a links tab 426. The index 418 can include a ranking of paid placements A and B entries 428 and 430 followed by nonpaid search results A and B entries 432 and 434. An advertising banner 436, that can be interactive, is advantageously selected to correspond to media purchase opportunities or collateral services related to a listing being depicted.

In FIG. 7, an illustrative methodology 500 for interfacing, searching and rating services begins in block 502 with a search data tuple from a client device being received in tuple space. In block 504, a search service provides an interface attribute that allows the client device to interact with services in the tuple space. In block 506, a search request is passed from the service tuple to one or more search engines, which places search result data tuples into tuple space in block 508. A rating service receives the search results in block 510 and forwards the results for bid to advertisers in block 512. The bids are received and optimized (e.g., revenue maximization by a greedy algorithm) in block 514. Acceptance of bids can be reported as a rating data tuple for tracking in block 516 in order to secure the revenue. In block 518, the rated results are formatted per the interface type and placed in tuple space in block 520 for the client device to retrieve.

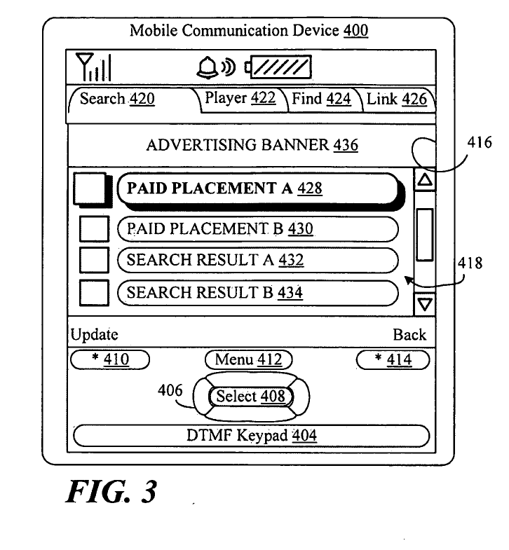

In FIG. 3, an illustrative mobile communication device 400 can serve as client device for remotely accessing and controlling interface, search and rating services via a graphical user interface (GUI) 402, which can include physical controls such as dial tone multi-function (DTMF) keypad 404, with four cursor keys 406 and select button 408, and left, middle and right menu buttons 410, 412, and 414. The GUI 402 can include a display 416 as depicted. Alternatively, a display with touch screen capability can also be used to provide soft input controls (not shown). The display 416 can depict a dynamic index 418 organized under a hierarchy of tabs of a search tab 420, player 422 tab, a find (local) tab 424 and a links tab 426. The index 418 can include a ranking of paid placements A and B entries 428 and 430 followed by nonpaid search results A and B entries 432 and 434. An advertising banner 436, that can be interactive, is advantageously selected to correspond to media purchase opportunities or collateral services related to a listing being depicted.

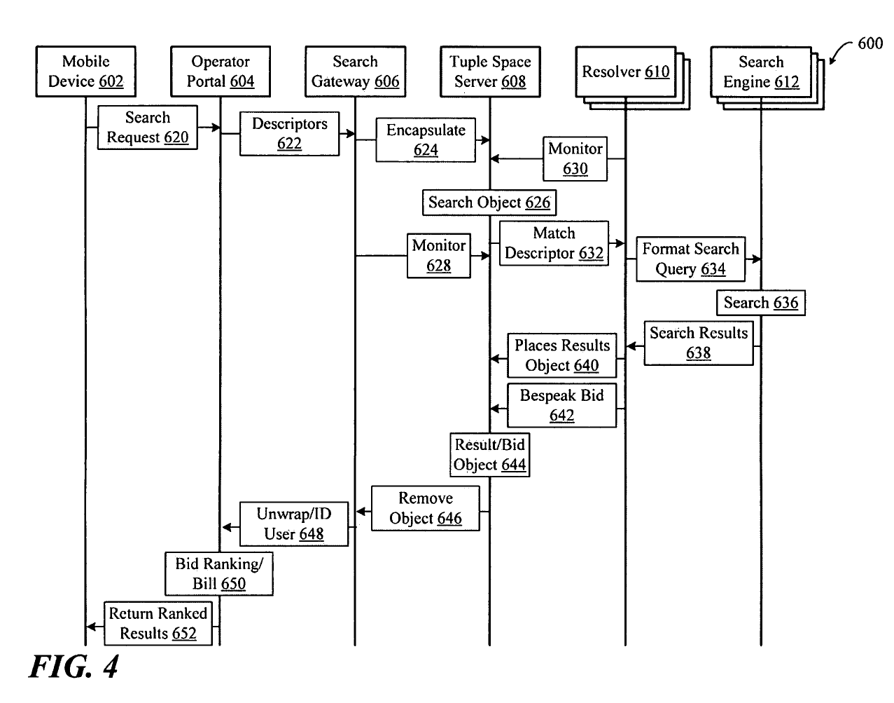

In FIG. 4, a methodology 600 for performing a distributed search on a loosely coupled network is depicted as calls between network entities of a mobile device 602, an operator portal 604, an operator search gateway 606, a Linda-type distributed (e.g., Tuple, etc.) space server 608, one or more search resolvers 610, and a respective search engine 612. A subscriber uses the mobile device 602 to send a search request (block 620) to the operator portal 604. For instance, the search terms could be Madonna or “ray of light.” The operator portal 604 forwards the search query (block 622), including descriptors and sufficient information to return the search results to the user, to the search gateway 606. The search gateway 606 in turn encapsulates the private object body with search descriptors (block 624), which can advantageously include bid factors to solicit a bid on search result ranking/inclusion. The search object 626 is placed in the tuple space maintained by the tuple space server 608 and the search gateway monitors the server 608 (block 628) for the results of the search request.

Pre-existing monitoring (block 630) of the tuple space by resolver(s) 610, or another connection that alerts the resolver 610, results in a match of search descriptors (block 632) of the search object 626. The search resolver 610 formats the search query to interface the search to a respective search engine 612 (block 634). The search engine 612 then performs a search (block 636) and returns the search results to the resolver 610 (block 638). The resolver 610 incorporates the search results into a tuple object, which includes the object body as received preserving a trace back to the other original user search even if invisible to the resolver 610 (block 640). In addition to placing the results object, the resolver 610 can include a bespeak bid to form a result/bid object 644 that is placed in the space maintained by the tuple server 608 (642).

The gateway 606 matches the search results and removes the object 644 from the space along with other search result objects placed in the space (block 646). The search gateway 606 unwraps the object 644 to collect the search results from one or more search result objects that correlate with the object body (block 648). For instances in which a bid is included, this information is utilized to rate and/or rank the search results as well as to bill the bidder for those bids that are accepted (block 650). The portal 604 returns the ranked search results to the user (block 652).

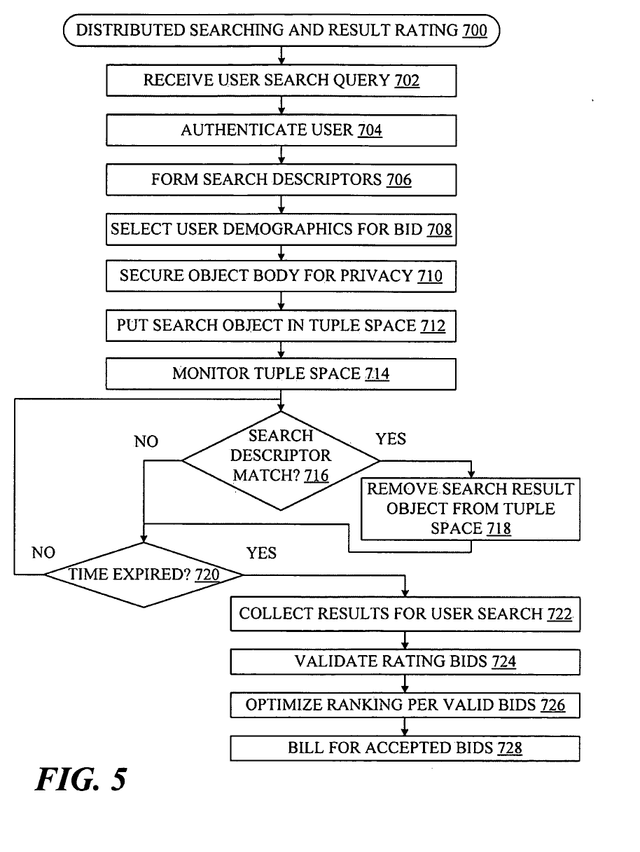

In FIG. 5, the collection of search results from a distributed search can be further enhanced by incorporating a methodology 700 for result rating bid upon by third parties (e.g., search engines, advertisers, etc.). In block 702, the user search query is received. The user is authenticated in block 704. Search descriptors are formed in block 706. For instance, the search query terms can be logically defined as being an exact phrase, a logical combination within certain proximity, plural forms explicitly added to the query, synonyms added to the query, etc. Certain classifications of the user can be added for purposes of inferring user preferences for search results. Advantageously, these user demographics can further be part of a solicited bid for search result placement in block 708. Not only is the search to be refined with projected user preferences or expectations, but the provider of the search results or other third party can bid on a value for placing a particular search results at a top of a listing or within a specified proximity to the top of the listing.

In block 710, information that would allow for specific identification of the user and/or client device is rendered private and added to a secure object body for subsequent return with the search results. The search object is then placed in a Linda-type distributed space (“tuple space”) in block 712. The search gateway for the operator can then monitor tuple space in block 714 for the results. Upon a tuple match found for search descriptor of a search result object in block 716, then the search result object is removed from tuple space 718. Thereafter, a further determination is made as to whether time has expired in block 720 for waiting for search results. This time expiration can be a range with a longer duration specified if no results have been detected and a shorter duration if at least one result object has been detected. If not expired in block 720 then processing returns to block 716. If expired in block 720, then the results for the user search are collected in block 722.

For those results associated with a bid, the bids are validated in block 724. The validation can comprise one or more of the following checks. First, a prequalification list can be referenced for entities that are allowed to bid to avoid disreputable entities from improperly dominating a search result ranking. Second, criteria can exclude certain items that poorly correlate with the search query from being highly placed. For instance, a third party could be willing to place a link for buying shoes to placed at the top of every list, regardless of whether anything related to shoes was in the shoe query. Either an independent correlation may be made or the list of trusted search engines can suffice to filter such spurious bids. Third, user authentication can be referenced for user preferences to exclude certain types of results. For instance, certain users may accept a lower subscription rate if they are willing to accepted search results associated with bids. Other users may exclude ranking results based upon bids in return for a premium subscription rate for search services. Fourth, the bid could contain preconditions that are excluded from acceptance, especially within the limited time constraints of an automated search.

The validated bids are then optimized for ranking in block 726. This optimization can be in accordance with a greedy algorithm that seeks revenue maximization. Constraints can be included to limit revenue generating search results to a certain portion of a display or to a certain numerical count (e.g., 1-3 listings). For emphasis, an accepted bid could be displayed in a highlighted manner, such as in the advertising banner, rather than the listing. Then, those bids that are accepted are noted for future billing intervals in block 728. This billing can reflect whether a listing is activated by the user as a condition for the bid, or to enhance the value of the bid.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or versions, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for facilitating a rated, distributed search, comprising:
defining a search rating bid process in a tuple space;
placing a search object in the tuple space based upon search query from a client device;
detecting a plurality of search result objects placed in the tuple space;
receiving at least one rating bid associated with a selected one of the plurality of search result objects; and
returning the search results to the client device with the selected one of the search results objects prominently ranked.

2. The method of claim 1, further comprising returning the search results to the client device via a cellular telephone network.

3. The method of claim 1, further comprising defining the search rating bid process in the tuple space by defining a tuple class for connecting a search engine resolver to the tuple space to monitor for the search object.

4. The method of claim 1, further comprising defining the search rating bid process in the tuple space by defining a tuple class for connecting a third party advertiser to bid on a search result object placed by a search engine resolver in the tuple space.

5. The method of claim 1, further comprising generating the search object that contains a search descriptor generated from a search query from the client device and that contains an object body privately comprising user data sufficient for returning search results to the client device.

6. The method of claim 1, further comprising generating the search object that contains a search descriptor generated from a search query from the client device and that contains a bid attribute soliciting the rating bid.

7. The method of claim 6, further comprising incorporating a user characteristic in the bid attribute soliciting the rating bid.

8. The method of claim 1, further comprising authenticating a user of the client device as a requirement for performing a search.

9. The method of claim 1, further comprising creating a billing event for an originating entity for the rating bid.

10. The method of claim 1, further comprising validating the rating bid as a condition of prominently ranking the associated search result.

11. The method of claim 10, further comprising verifying an originating entity for the rating bid against an approved list to validate the rating bid.

12. The method of claim 10, further comprising validating conditions of the rating bid against a bid solicitation criterion t validate the rating bid.

13. The method of claim 1, further comprising performing a revenue optimization operation in response to receiving a plurality of rating bids.

14. At least one processor configured to facilitate a rated, distributed search, comprising:
a first module for defining a search rating bid process in a tuple space;
a second module for placing a search object in the tuple space based upon search query from a client device;
a third module for detecting a plurality of search result objects placed in the tuple space;
a fourth module for receiving at least one rating bid associated with a selected one of the plurality of search result objects; and
a fifth module for returning the search results to the client device with the selected one of the search results objects prominently ranked.

15. A computer program product for facilitating a rated, distributed search, comprising:
a computer-readable medium, comprising:
at least one instruction for causing a computer to define a search rating bid process in a tuple space;
at least one instruction for causing the computer to place a search object in the tuple space based upon search query from a client device;
at least one instruction for causing the computer to detect a plurality of search result objects placed in the tuple space;
at least one instruction for causing the computer to receive at least one rating bid associated with a selected one of the plurality of search result objects; and
at least one instruction for causing the computer to return the search results to the client device with the selected one of the search results objects prominently ranked.

16. An apparatus for facilitating a rated, distributed search, comprising:
means for defining a search rating bid process in a tuple space;
means for placing a search object in the tuple space based upon search query from a client device;
means for detecting a plurality of search result objects placed in the tuple space;
means for receiving at least one rating bid associated with a selected one of the plurality of search result objects; and
means for returning the search results to the client device with the selected one of the search results objects prominently ranked.

17. An apparatus for facilitating a rated, distributed search, comprising:
a tuple space;
an operator portal for receiving a search query from a client device;
a search gateway connected to the operator portal and to the tuple space operable to place a search object in the tuple space based on the search query from a client device, to detect a plurality of search result objects placed in the tuple space, to receive at least one rating bid associated with a selected one of the plurality of search result objects,
wherein the operator portal returns the search results to the client device with the selected one of the search results objects prominently ranked responsive to the rating bid.

18. The apparatus of claim 17, further comprising a cellular telephone network communication link between the operator portal and the client device.

19. The apparatus of claim 17, further comprising the search gateway defining the search rating bid process in the tuple space by defining a tuple class for connecting a search engine resolver to the tuple space to monitor for the search object.

20. The apparatus of claim 17, further comprising the search gateway defining the search rating bid process in the tuple space by defining a tuple class for connecting a third party advertiser to bid on a search result object placed by a search engine resolver in the tuple space.

21. The apparatus of claim 17, further comprising the search gateway generating the search object that contains a search descriptor generated from a search query from the client device and that contains an object body privately comprising user data sufficient for returning search results to the client device.

22. The apparatus of claim 17, further comprising the search gateway generating the search object that contains a search descriptor generated from a search query from the client device and that contains a bid attribute soliciting the rating bid.

23. The apparatus of claim 22, further comprising the search gateway incorporating a user characteristic in the bid attribute soliciting the rating bid.

24. The apparatus of claim 17, further comprising the operator portal authenticating a user of the client device as a requirement for performing a search.

25. The apparatus of claim 17, further comprising the search gateway creating a billing event for an originating entity associated with the accepted rating bid.

26. The apparatus of claim 17, further comprising the search gateway validating the rating bid as a condition of prominently ranking the associated search result.

27. The apparatus of claim 26, further comprising the search gateway verifying an originating entity for the rating bid against an approved list to validate the rating bid.

28. The apparatus of claim 26, further comprising the search gateway validating conditions of the rating bid against a bid solicitation criterion t validate the rating bid.

29. The apparatus of claim 17, further comprising the search gateway performing a revenue optimization operation in response to receiving a plurality of rating bids.

30. A method for requesting a rated, distributed search, comprising:
accepting input of a search query into a user interface of a client device;
sending the search query to a network that defines a search rating bid process in a tuple space, places a search object in the tuple space from a client device, detects a plurality of search result objects placed in the tuple space, receives at least one rating bid associated with a selected one of the plurality of search result objects; and
receiving the search results to the client device with the selected one of the search results objects prominently ranked by the network.

31. The method of claim 30, further comprising sending the search query to the network and receiving the returned search results via a cellular telephone network.

32. The method of claim 30, further comprising sending the search query to the network that defines the search rating bid process in the tuple space by defining a tuple class for connecting a search engine resolver to the tuple space to monitor for the search object.

33. The method of claim 30, further comprising sending the search query to the network that defines the search rating bid process in the tuple space by defining a tuple class for connecting a third party advertiser to bid on a search result object placed by a search engine resolver in the tuple space.

34. The method of claim 30, further comprising sending the search query to the network that generates the search object containing a search descriptor generated from a search query from the client device and that contains an object body privately comprising user data sufficient for returning search results to the client device.

35. The method of claim 30, further comprising sending the search query to the network that generates the search object that contains a search descriptor generated from a search query from the client device and that contains a bid attribute soliciting the rating bid.

36. The method of claim 35, further comprising sending the search query to the network that incorporates a user characteristic in the bid attribute soliciting the rating bid.

37. The method of claim 30, further comprising sending the search query to the network that authenticates a user of the client device as a requirement for performing a search.

38. The method of claim 30, further comprising sending the search query to the network that creates a billing event for an originating entity for the rating bid.

39. The method of claim 30, further comprising sending the search query to the network that validates the rating bid as a condition of prominently ranking the associated search result.

40. The method of claim 39, further comprising sending the search query to the network that validates an originating entity for the rating bid against an approved list to validate the rating bid.

41. The method of claim 39, further comprising sending the search query to the network that validates conditions of the rating bid against a bid solicitation criterion t validate the rating bid.

42. The method of claim 30, further comprising sending the search query to the network that performs a revenue optimization operation in response to receiving a plurality of rating bids.

43. At least one processor configured to request a rated, distributed search, comprising:
a first module for inputting a search query into a user interface of a client device;
a second module for sending the search query to a network that defines a search rating bid process in a tuple space, places a search object in the tuple space from a client device, detects a plurality of search result objects placed in the tuple space, receives at least one rating bid associated with a selected one of the plurality of search result objects; and
a third module for receiving the search results to the client device with the selected one of the search results objects prominently ranked by the network.

44. A computer program product for requesting a rated, distributed search, comprising:
a computer-readable medium, comprising:
at least one instruction for causing a computer to accept input of a search query into a user interface of a client device;
at least one instruction for causing the computer to send the search query to a network that defines a search rating bid process in a tuple space, places a search object in the tuple space from a client device, detects a plurality of search result objects placed in the tuple space, receives at least one rating bid associated with a selected one of the plurality of search result objects; and
at least one instruction for causing the computer to receive the search results to the client device with the selected one of the search results objects prominently ranked by the network.

45. An apparatus for requesting a rated, distributed search, comprising:
means for accepting input of a search query into a user interface of a client device;
means for sending the search query to a network that defines a search rating bid process in a tuple space, places a search object in the tuple space from a client device, detects a plurality of search result objects placed in the tuple space, receives at least one rating bid associated with a selected one of the plurality of search result objects; and
means for receiving the search results to the client device with the selected one of the search results objects prominently ranked by the network.

46. An apparatus for requesting a rated, distributed search, comprising:
a user interface of a client device for accepting input of a search query; and
a communication component for sending the search query to a network that defines a search rating bid process in a tuple space, placing a search object in the tuple space from a client device, detecting a plurality of search result objects placed in the tuple space, receiving at least one rating bid associated with a selected one of the plurality of search result objects, and receiving the search results to the client device,
wherein the user interface presents the search results with the selected one of the search results objects prominently ranked by the network.

47. The apparatus of claim 46, further comprising the communication component sending the search query to the network and receiving the returned search results via a cellular telephone network.

48. The apparatus of claim 46, further comprising the communication component sending the search query to the network that defines the search rating bid process in the tuple space by defining a tuple class for connecting a search engine resolver to the tuple space to monitor for the search object.

49. The apparatus of claim 46, further comprising the communication component sending the search query to the network that defines the search rating bid process in the tuple space by defining a tuple class for connecting a third party advertiser to bid on a search result object placed by a search engine resolver in the tuple space.

50. The apparatus of claim 46, further comprising the communication component sending the search query to the network that generates the search object containing a search descriptor generated from a search query from the client device and that contains an object body privately comprising user data sufficient for returning search results to the client device.

51. The apparatus of claim 46, further comprising the communication component sending the search query to the network that generates the search object that contains a search descriptor generated from a search query from the client device and that contains a bid attribute soliciting the rating bid.

52. The apparatus of claim 51, further comprising the communication component sending the search query to the network that incorporates a user characteristic in the bid attribute soliciting the rating bid.

53. The apparatus of claim 46, further comprising the communication component sending the search query to the network that authenticates a user of the client device as a requirement for performing a search.

54. The apparatus of claim 46, further comprising the communication component sending the search query to the network that creates a billing event for an originating entity for the rating bid.

55. The apparatus of claim 46, further comprising the communication component sending the search query to the network that validates the rating bid as a condition of prominently ranking the associated search result.

56. The apparatus of claim 55, further comprising the communication component sending the search query to the network that validates an originating entity for the rating bid against an approved list to validate the rating bid.

57. The apparatus of claim 55, further comprising the communication component sending the search query to the network that validates conditions of the rating bid against a bid solicitation criterion t validate the rating bid.

58. The apparatus of claim 46, further comprising the communication component sending the search query to the network that performs a revenue optimization operation in response to receiving a plurality of rating bids.
